(19) United States
(12) Patent Application Publication
(10) Pub. No.: US 2021/0360936 A1
(43) Pub. Date: Nov. 25, 2021

(54) DOUGH HANDLING UNIT AND APPARATUS FOR AND A METHOD OF HANDLING DOUGH

(71) Applicant: VEMAG MASCHINENBAU GMBH, Verden (DE)

(72) Inventors: Claus Kastell-Belke, Langwedel-Etelsen (DE); Karsten Siegmanski, Verden (DE); Frank Siegfried Bretschneider, Cottbus (DE)

(21) Appl. No.: 17/324,765

(22) Filed: May 19, 2021

(30) Foreign Application Priority Data
May 20, 2020 (DE) 102020113660.9

(51) Int. Cl. A21C 1/06; A21C 1/14

(52) U.S. Cl. CPC A21C 1/06; A21C 1/144; A21C 1/142

(57) ABSTRACT

The invention concerns a dough handling unit (1, 1′) for handling dough comprising a housing (8, 8′, 8″), a dough inlet (10, 10′) for introducing dough into the housing (8, 8′, 8″), a dough outlet (12, 12′) for discharge of the dough from the housing (8, 8′, 8″), and a handling chamber for handling the dough, that is arranged within the housing (8, 8′, 8″) along a portion between the inlet and the outlet and is substantially closed off relative to the surroundings, wherein arranged in the handling chamber (2, 2′) is a dough structuring portion (4, 4′, 4″) having a nozzle (6, 6′, 6″) which reduces the flow cross-section for structuring of the dough, and downstream of the nozzle (6, 6′, 6″) the flow cross-section in the dough structuring portion is enlarged again in relation to the reduced flow cross-section in the region of the nozzle (6, 6′, 6″).

### BACKGROUND

The invention concerns a dough handling unit for handling dough comprising a housing, a dough inlet for introducing dough into the housing, a dough outlet for discharge of the dough from the housing, and a handling chamber for handling the dough, that is arranged within the housing along a portion between the inlet ad the outlet and is substantially closed off relative to the surroundings. In addition the invention also concerns an apparatus for processing dough comprising a filling machine for the delivery of dough, that includes a filling hopper for receiving dough and a delivery pump for delivering the dough, and a method of processing dough.

Apparatuses are known in the state of the art, which are used for the automated production and processing of dough for bread or the like. The dough which is sometimes already finished can be subjected to further processing by means of such apparatuses, in particular the dough is subdivided into portions of predetermined size.

The known processing apparatuses usually have a filling machine for the delivery or transportation of dough along a processing section. The filling machine usually includes a filling hopper for receiving dough in the form of a feed means for feeding the dough into the apparatus. The filling machine further includes a delivery pump, by means of which the dough is moved from the filling hopper in the direction of a dough discharge. The dough is discharged at the dough discharge in portions of predetermined size.

During delivery or transportation of the dough through the filling machine the dough is usually turned and rolled over, and kneaded to completion, if necessary, in which case the dough can be subjected to changing shearing stresses. The rolling operations or shearing stresses during kneading affect the structure of the dough to be further processed. In the case of doughs damage can occur within the dough structure. The consequence is frequently a partially damaged gluten film which causes reduced and/or irregular gas retention within the dough. After kneading, the doughs are reprocessed by rounding, intermediate proofing and shaping in order to counteract potential damage to the dough.

DE 10 2011 083 356 A1 discloses an apparatus for processing foodstuffs, which has a delivery device for receiving and delivering a foodstuff along a delivery path, wherein downstream of the delivery device there is a handling chamber, within which a kneading means is arranged drivably in rotation, adapted to subject the foodstuff to post-treatment. The kneading means is intended to effect restoration of the damaged dough structure, in particular the aim being to restore the sticky network effect or the sticky structure within the gluten structure by careful post-kneading. It has been found however that this kind of post-handling does not always lead to the desired preparation of the dough.

### SUMMARY

Taking the foregoing problems as the basic starting point the object of the invention is to provide a dough handling unit for handling dough, an apparatus and a method of processing dough, which permit an increase in the product quality of the dough even with differing composition. Another object of the invention is to reduce the amount of energy and technological effort involved in the preparation of dough, while maintaining at least the same product quality.

The invention attains the underlying object in a dough handling unit for handling dough having the features of claim 1. In particular disposed in the handling chamber is a dough structuring portion having a nozzle which reduces the flow cross-section for structuring the dough and downstream of the nozzle the flow cross-section in the dough structuring portion is enlarged again in relation to the reduced flow cross-section in the region of the nozzle.

According to the invention in the present case the approach adopted is that, instead of conventional careful post-handling of the dough which preferably was previously delivered by a delivery screw, for restoring the sticky network effect within the gluten structure, that dough is now subjected to a controlled stress loading. In the state of the art the approach adopted on the part of the men skilled in the art for a long time, presumably centuries, is that post-handling for reprocessing of the dough after a delivery operation, for example by means of a delivery pump, may only be performed very gently. In contrast to that prevailing view the invention uses a nozzle which reduces the flow cross-section for the dough to be delivered, for structuring/restructuring the dough, and further proposes that downstream of the nozzle the flow cross-section is enlarged again after the nozzle. Surprisingly and contrary to the judgements (prejudices) among the men skilled in the art it has been found that a less careful handling procedure can be carried out with a per se known nozzle, which however surprisingly results in positive structuring or restructuring of the dough. After substantial circulatory rolling and shearing in a filling flow divider or a delivery pump with a so-called delivery curve or other delivery elements or a kneader a nozzle is now proposed according to the invention, by means of which a one-step process is implemented during post-treatment. Contrary to existing prejudices it has been surprisingly established thereby that the quality of the dough can be substantially improved. In other words according to the invention the dough is deliberately stressed and thus structurally reprocessed, thus transforming a chaotic gluten structure into an ordered gluten structure. Instead of careful gentle reprocessing of the dough, structuring or restructuring of the dough structure is effected, in which structure-forming proteins form films of large area and high levels of surface tension can build up in the material. When flowing through the nozzle, the dough is preferably subjected to a relatively high delivery pressure of at least 15 bar. The delivery pressure is in a range of about 15 bar to approximately 50 bar. It is preferable that only the nozzle is arranged in the handling chamber as a fixed or non-adjustable component of the dough structuring portion. The handling chamber is preferably free of moving, in particular of rotating processing tools. In comparison with conventionally prepared doughs, doughs which are restructured in that way have a larger number of fine micropores, within which fermentation gases can be more greatly held. Tests have shown that the gluten structure is positively influenced, and a higher surface tension and fine micropore distribution can be achieved. Accordingly as a result a baked item produced from a dough which has been restructured in accordance with the invention in that way has finer pores, is more fluffy and has greater bulk. A dough produced in this manner is clearly superior to known pastry properties in terms of pastry volume, crumb structure and texture.

According to a preferred development of the present invention the nozzle, in dependence on the quality or the composition of the dough to be handled, is adapted to structure/restructure the dough passing the handling chamber. By means of a nozzle which is used in that way in a handling chamber and by means of which firstly the flow cross-section is reduced in the handling chamber and which thereafter increases again preferably mechanical stressing of the dough is effected in a plurality of directions at the same time, preferably three-dimensional stressing, without the shearing limit of the gluten films within the dough being reached. The nozzle is accordingly of such a configuration that the dough to be structured/restructured is taken to its loading limit. It is only in that way that after possible damage to the dough by for example previously effected delivery by means of a delivery pump of a filling machine that the formation of thin gluten films of large area can be achieved within the dough. Doughs which are simultaneously mechanically stressed in a plurality of directions are distinguished by substantially higher surface tension levels and baked products produced therefrom are distinguished by a fine pore structure and a large volume.

A development of the dough handling unit according to the invention provides that the nozzle has a central passage opening which is of a uniform flow cross-section in the flow direction of the dough at least portion-wise along the dough structuring portion. The central passage opening provides for simple and above all efficient mechanical stressing of the dough to be post-treated, in which the dough is stressed simultaneously in a plurality of directions. In that case the reduction in the flow cross-section at the central passage opening is so selected that the shearing limit of the gluten structure within the dough to be handled is not reached. Observing the shearing limit provides for avoiding further damage to the dough to be post-handled. Instead structuring/restructuring of the dough is effected by way of the central passage opening, and the desired rheological properties can be “freshly” produced by means of the structuring/restructuring.

Preferably the central passage opening is of a substantially circular cross-section with a central axis arranged coaxially with respect to the longitudinal axis of the wall of the housing, wherein preferably the housing is of a substantially rotationally symmetrical shape. With the coaxial arrangement of the central axis of the passage opening with respect to the longitudinal axis of the housing wall uniform post-handling and thus structuring/restructuring of the dough passed through the nozzle is effected in the handling chamber over the entire periphery of the nozzle. In a preferred configuration in which the passage opening of the nozzle is of a circular cross-section and the housing wall is in the form of a kind of cylindrical tube, with a coaxial arrangement the central passage opening, over its entire periphery in the radial direction, is at an approximately uniform spacing relative to the housing wall of the remaining handling chamber upstream and downstream of the nozzle.

Preferably the nozzle has a passage opening of a diameter which in relation to the diameter of the housing wall of the dough structuring portion upstream and downstream of the nozzle is in a ratio which is in the range of approximately 1:3 to about 1:12. Accordingly in dependence on the properties of the dough to be handled a sufficiently high mechanical stressing in preferably a plurality of directions is simultaneously effected, which ensures structuring/restructuring of the dough to be handled. In addition within the specified range of the reduction in cross-section, this arrangement ensures that the shearing limit of the gluten structure within the dough to be handled is not reached.

Preferably upstream of the passage opening the dough structuring portion is of a flow cross-section which continuously decreases in the flow direction. The continuously decreasing cross-section preferably provides for uniform mechanical three-dimensional stressing of the dough for the structuring/restructuring that is to be performed for the dough. In addition the continuous reduction in cross-section avoids an abrupt deflection of the dough in the structuring portion and thus overloading of the gluten structure in the dough to the shearing limit thereof.

In a preferred configuration of the dough handling unit according to the invention the flow cross-section which continuously decreases in the flow direction is in the form of a conically tapering entry cone. That further improves the uniform mechanical stressing of the dough during the structuring/restructuring process. Preferably the nozzle in the handling chamber has an entry or an entry opening and an exit or an exit opening within the chamber. The portion between the entry opening and the central passage opening for the dough is preferably completely in the form of a conically tapering entry cone.

Preferably the entry cone has a cone angle in the range of about 100° to 120°. Within the specified range the dough is sufficiently mechanically stressed without being over-stressed. The cone angle of the entry cone of the nozzle according to the invention can vary depending on the nature of the dough to be processed.

According to a preferred development of the dough handling unit according to the invention the dough structuring portion downstream of the central passage opening is of a flow cross-section which continuously enlarges again in the flow direction. Following the increase in pressure which is generated in the entry region of the nozzle, by virtue of the reduction in the flow cross-section, there is a stress relief phase, by means of which the structuring/restructuring process which is to be performed on the dough is first concluded. The formation of thin gluten films of large area within the dough to be treated is further promoted by the implemented continuous stress relief phase, after passing through the central passage opening.

In a preferred embodiment the flow cross-section which continuously enlarges in the flow direction is in the form of a conically enlarging exit cone. The conical exit cone preferably directly follows the central passage opening, with its flow cross-section which preferably remains the same, and extends as far as the exit or the exit opening at the nozzle.

Preferably the exit cone of the nozzle has a cone angle in the range of about 115° to 135°. Preferably the dough in the exit cone after passing through the central opening is relieved of stress more quickly in comparison with the entry region with the smaller cone angle at the entry cone. In a preferred embodiment of the invention the exit or the exit opening of the nozzle is of a reduced cross-section in comparison with the entry or entry opening on the nozzle. In an embodiment of the invention the handling chamber has an abrupt increase in cross-section in the transition from the exit to the following portion in the handling chamber. In addition in a preferred configuration the angle dimension of the cone angle at the exit cone is always greater than the angle dimension of the cone angle at the entry cone of the nozzle according to the invention.

A preferred development of the dough handling unit according to the invention provides that downstream of the dough structuring portion is an adjoining substantially cylindrical space which is preferably adapted for portioning of the dough. The structured/restructured dough is portioned in the portion of the handling chamber adjoining the nozzle. Preferably the dough is subdivided into portions of the same size or subdivided into a plurality of mass flows of the same size. With the dough handling unit according to the invention it is possible to perform restructuring of the dough, which in the embodiment described above is preferably carried out directly before portioning of the dough.

Preferably the length of the handling chamber and the length of the nozzle are in a ratio of about 4:1. The specified ratio is preferably a minimum, for which reason the length of the portion of the handling chamber, which adjoins the dough structuring portion, can also be greater. That provides for preferably uniform portioning of the dough. Preferably the space provided downstream of the nozzle is of a substantially round cross-section which is of the same cross-sectional size over its entire length. That provides for particularly careful and gentle delivery of the already structured/restructured dough to the dough outlet at the dough handling unit.

According to a preferred development of the invention, at least one baffle for the dough being delivered in the direction of the dough outlet is additionally arranged in the handling chamber downstream of the nozzle, said baffle preferably being connected immediately downstream of an increase in cross-section. In particular, any chaotic structuring produced in the dough during the delivery process by the delivery and/or portioning device, is undone. When a dough to be processed is relaxed in the handling chamber, at least for a period of time or in sections, this results in a further form of restructuring and/or repolymerisation of the dough structure. With the aid of the baffle, the uniform pore structure inside the foodstuff can be further improved. In the case of doughs, this results in preferably even retention of gas inside the dough, which ultimately results in higher product quality.

According to a development of the invention, one or more baffles are preferably designed and arranged in such a way that the handling chamber has at least one path section with a varying flow cross-section and/or with a changing delivery direction of the dough. By means of the at least one baffle provided in the handling chamber, the foodstuff is preferably subjected to further processing or treatment after the nozzle, without movable processing means being used. The dough to be handled is preferably relaxed in the handling chamber for at least for a period of time, or in sections. As a result, the dough to be handled is preferably subjected to further restructuring and/or repolymerisation. A partially affected dough structure can thus be further processed accordingly, so that the gluten network effect within the gluten structure of a dough is improved.

In a preferred configuration the dough is integral with at least a part of the housing of the handling unit. Accordingly the nozzle is a fixed component of the entire dough handling unit so that, in the event of a change in nozzle becoming due, by virtue of a change in product at the processing apparatus, the entire handling unit possibly has to be replaced. Preferably with that structure the entire dough handling unit is adapted to the properties of the dough material to be processed by means of a processing apparatus. Preferably by virtue of the integral configuration with at least a part of the housing of the dough handling unit according to the invention, the nozzle is accordingly an integral component part thereof.

In an alternative configuration the dough structuring portion with its nozzle is in the form of a separate component and is replaceably mounted in a portion of the handling chamber of the dough handling unit according to the invention. The design configuration of the dough structuring portion or preferably the nozzle in the form of a separately replaceable component permits simplified and in particular individual adaptation of the dough handling unit according to the invention to a possible change in properties of a dough to be processed after a possible change in product. The separate configuration of the nozzle relative to the handling unit means that if necessary only the nozzle has to be replaced without the entire handling unit having to be changed. Preferably a nozzle which is replaceable on a handling unit has arresting elements which cooperate with the handling unit and which, during dough processing, in particular when the dough is being pressed through the nozzle, prevent unwanted displacement of the dough within the handling chamber of the handling unit.

In a preferred configuration the nozzle has plastic or metal as its material or is formed from plastic, metal or a combination of the two materials. In the present case materials are used, which comply with the necessary demands in terms of the processing of foodstuffs, in particular the dough materials which are to be worked in the present case.

A further aspect of the present invention concerns an apparatus for processing dough comprising a filling machine for the delivery of dough, which includes a filling hopper for receiving dough and a delivery pump for the delivery of dough.

The apparatus attains the object set forth in the opening part of this specification, in that the filling machine is coupled to a dough handling unit according to one of the above-described preferred embodiments, arranged downstream of the delivery pump.

The apparatus according to the invention therefore includes a dough handling unit according to the invention arranged downstream of the filling machine, that is to say in the delivery direction after the filling machine. That advantageously provides that the previously damaged dough, caused by the delivery process and the circulatory rolling involved therewith of the dough, is structured/restructured in such a way that the internal stresses in the gluten structure within the dough are compensated after passing through the handling unit. In that situation the dough is subjected to a controlled stress loading, that is to say the dough is processed or stressed in a specifically targeted fashion. Instead of gentle careful processing of the dough structuring or restructuring of the dough structure is effected, in which structure-forming proteins form thin gluten films of large area and high levels of surface tension can occur in the material. Doughs which are restructured in that way, in comparison with conventionally worked doughs, have a larger number of fine micropores, within which fermentation gases can be more greatly held. Accordingly as a result a baked product produced from a dough which has been restructured in accordance with the invention in that way is more finely pored, fluffier and bulkier. By means of the structurally simplified dough handling unit, it is also possible to increase the dough processing output to twice the dough processing volumes that are otherwise normal.

In a preferred configuration of the apparatus according to the invention it further has a dough feed opening, a dough discharge opening and a processing section which extends between the feed opening and the discharge opening and which is substantially closed in relation to the surroundings. The dough is introduced into the apparatus by way of the feed opening, wherein generally the feed opening is in the form of a filling hopper. A predetermined amount of dough to be processed is introduced into the filling hopper. The dough is then delivered from the filling hopper along the closed processing section by means of a delivery pump of the filling machine. With its passage through the preferably closed processing section the dough which is damaged by the delivery process, after passing through the delivery pump, passes into the handling apparatus. Within the handling apparatus the dough is then restructured and acquires the desired properties for further processing. The provision of a closed processing section provides that the dough to be processed is not exposed to any external influences or could possibly be contaminated, whereby the dough quality could be detrimentally influenced.

A separating device for subdividing the dough into individual portions is preferably assigned to the dough outlet of the dough handling unit. The dough outlet has an exit opening of defined geometry, also referred to as a nozzle, where the dough leaves the handling chamber and is subdivided into individual portions by means of the separating device.

A development of the apparatus according to the invention provides a portioning device for subdividing the dough passing the processing section into individual portions or into a plurality of same-size mass flows, wherein the dough handling unit is preferably arranged immediately before or after the portioning device. With the dough handling unit according to the invention it is possible for the dough to be restructured immediately before or after it was portioned. In that way the dough to be processed acquires the desired property at a time in the processing procedure in which damage to the gluten structure of the dough which is to be further processed is subsequently kept as slight as possible. In that way, after discharge from the dough discharge opening, the dough preferably has the desired rheological properties without further complicated and expensive post-processing by any further processing steps which are additionally to be performed, like for example rounding or long molding.

Preferably the apparatus according to the invention is distinguished by at least one feed location in the processing section for additives to be added to the dough to be handled. The feed locations can preferably be arranged before or after the dough handling unit. By means of the feed location which has at least one feed opening it is possible to introduce into the processing section solid or liquid additives which promote structuring/restructuring of the dough to be treated. In an embodiment of the invention it is also possible for a plurality of feed locations to be arranged along the processing section.

In a preferred development of the processing apparatus according to the invention the portioning device includes a separating device for subdividing the foodstuff into individual portions, wherein the separating device preferably has at least one moveable blade. Preferably the separating device is associated with the dough discharge opening. In particular after structuring/restructuring of the dough the dough is subdivided into individual portions preferably with discharge of the restructured dough from the dough discharge opening. The subdivision operation is effected using one or more moveable, in particular rotatable separating blades. Each moveable separating blade is preferably moved continuously and passes the dough discharge opening at predetermined intervals. As it passes the dough discharge opening the dough which is being continuously or cyclically delivered along the processing section is subdivided into portions of a desired size or mass.

In a possible configuration of the present invention the delivery pump is in the form of a worm pump, a double-spindle pump, a gear pump or a vane pump for the delivery and/or portioning of the foodstuff. An optimum degree of filling is preferably achieved within the processing section by means of the delivery pump. Delivery of the dough by means of the pump is preferably effected continuously, in batches or cyclically with a substantially continuous mass flow.

According to a further aspect the invention concerns a method of processing dough including the steps introducing a dough into a dough feed opening of a substantially closed processing section, delivering the dough in the processing section by means of a filling machine in the direction of a dough discharge opening. The method also attains the object stated in relation to the dough handling unit according to the invention in that the dough passes through a handling unit which is arranged after the filling machine in the delivery direction of the dough, and with the step of handling the dough in the handling unit by passing the dough through a dough structuring portion with a nozzle reducing the flow cross-section for structuring/restructuring of the dough. The method according to the invention adopts the approach, instead of gentle dough processing which is usual in the state of the art, of now implementing mechanical stressing of the dough, causing restructuring of the gluten structure within the dough. That results in compensation for stresses in the interior of the gluten structure and thin gluten films of large area are formed, which have a substantially higher surface tension. As a result the proportion of fine pores within the dough is improved, whereby gas retention is improved. Dough materials which have been processed by means of such a method according to the invention can be used to produce baked products which are more fine-pored, fluffy and bulky than baked products produced with conventional dough processing methods. What is crucial in the present case is that mechanical stressing of the dough is effected by means of the nozzle in the post-treatment operation without reaching the shearing limit of the gluten structure within the dough.

In a development the method includes at least one, more or all of the following steps: handling the dough by targeted mechanical stressing of the dough in a plurality of directions, then enlarging the flow cross-section when passing through the nozzle, and portioning of the dough before or after handling of the dough by means of a portioning device. When handling the dough, instead of being stressed in only one direction as is the case for example in known kneading methods, the dough is preferably simultaneously mechanically stressed in a plurality of directions, that is to say three-dimensionally. Preferably mechanical stressing in the correct relationship with the basic properties of the dough to be processed is decisive. It may therefore be necessary that the mechanical treatment is adapted in dependence on the doughs to be processed. In particular replacement of the nozzle within the processing section may be necessary depending on the doughs to be processed, in particular in connection with a product change to be implemented. Preferably with a change in the nozzle in the processing section, the ratio of the change in cross-section in the handling chamber is suitably adapted. In the case of a reduction in cross-section there is an increase in the pressure upstream of the nozzle, acting on the dough to be handled. After passing through a central passage opening the flow cross-section is enlarged again, whereby the dough can be relieved of stress again in a portion of the nozzle. Preferably the dough is continuously compressed along a portion of the nozzle and passes through a portion of the nozzle, within which it is continuously relieved of stress again.

As the dough temperature increases, the degree of cross-linking in the dough increases, which causes the doughs to change their material behaviour. A distinctive viscoelastic behaviour ensues. Such doughs are sensitive to directional mechanical stress. The reason is that the gluten network in the dough can only tolerate a limited build-up of tension in one direction and then tears. Pastries made of these doughs are coarse-pored and small in volume. Multiple changes in the direction of mechanical load on the gluten network of the dough compensates for the internal tensions in the gluten structure and results in the formation of thin gluten films of large area, which feature a significantly higher surface tension. Pastries made of these doughs have fine pore and a large volume.

In these methods, the dough is conveyed by means of a pump or similar through a handling chamber in which the dough is structured. The cross-sectional geometry of the chamber determine how the dough is shaped, which is portioned from a continuous flow of dough into baking tins or onto proofing trays by means of a roller cutter. The continuously rotating roller cutter is a cutting device with no chamber volume of its own. A continuously conveyed stream of dough is cut at the chamber outlet. Variations in the dough density are compensated for in advance by reducing the cross-section. The portioning capacity can theoretically be increased until the tear-off time is reached.

The advantage of the method is that it affects the cross-linking of the proteins and consequently the pore structure of the dough and the crumb of the pastry. The new method is characterised as follows:

The dough is structured, shaped and portioned in one step.

The rheological behaviour of one and the same dough can be influenced by changing the processing unit (tool geometry and processing parameters). The dough behaviour can be shifted from plastic behaviour to viscoelastic or viscous dough behaviour by applying shear forces. The pore structure of the dough changes only slightly and results in an almost identical crumb structure (foam structure) in the pastry.

The apparatus produces a spatial tension equilibrium in the dough. By applying and relieving loads on the protein structure in the dough, the disordered protein structure in the kneaded dough is transformed into an ordered protein film and network structure, which is caused by biochemical redox reactions. If the tension equilibrium is spatially balanced, stabile protein films of large area are formed that cross-link more strongly with each other. As a result, the surface tension of the protein network in the dough increases, and the air and fermentation gases worked into the dough are kept stable as micro-inclusions (miniature gas inclusions). Baking results in a fine-pored pastry crumb.

In mechanical engineering terms, production of a stable spatial structure is determined by the combination of tools and machine parameters (vibration frequency, changes in cross-section, rotation speed, fixtures (baffles, static mixers and the like)) and the length of the handling unit. The geometry of the tools and the length of the handling unit, and their relationship to each other, determine the ratio of tension and relaxation in the dough.

The dough is shaped by the cross-section of the handling chamber into an (endless) continuous stream of dough and is divided by a dividing device. The pieces of dough are portioned directly into baking tins/proofing baskets.

Furthermore in another aspect the invention also concerns the use of a nozzle in a dough handling unit.

This use attains the above-indicated object in that a nozzle is fitted in a handling unit according to one of the above-described preferred embodiments for structuring/restructuring of the dough.

The preferred embodiments or developments described in relation to the dough handling unit according to the invention are at the same time also preferred configurations of the processing apparatus according to the invention, the method according to the invention and the use of an nozzle in a dough handling unit according to the invention. For the avoidance of repetition attention is directed to the foregoing description.

### BRIEF DESCRIPTION OF THE DRAWINGS

The invention is described in greater detail hereinafter by means of a preferred embodiment with reference to the accompanying drawings in which:

FIG. 1 shows a perspective view of an apparatus for processing dough with a handling device according to the invention,

FIG. 2 shows a partial view in section of the processing apparatus according to the invention as shown in FIG. 1,

FIG. 3 shows a sectional view of the handling device of FIG. 2,

FIG. 4 shows a view of a further embodiment of a dough handling unit,

FIG. 5 shows a perspective view of a further embodiment of an apparatus according to the invention for processing dough,

FIG. 6 shows a partial view in section of the processing apparatus of FIG. 5,

FIG. 7 shows a view of a portioning device with a dough handling unit according to the invention as a plan view in section, and

FIG. 8 shows a view in longitudinal section of the portioning device with the dough handling unit arranged therein as shown in FIG. 5.

### DETAILED DESCRIPTION

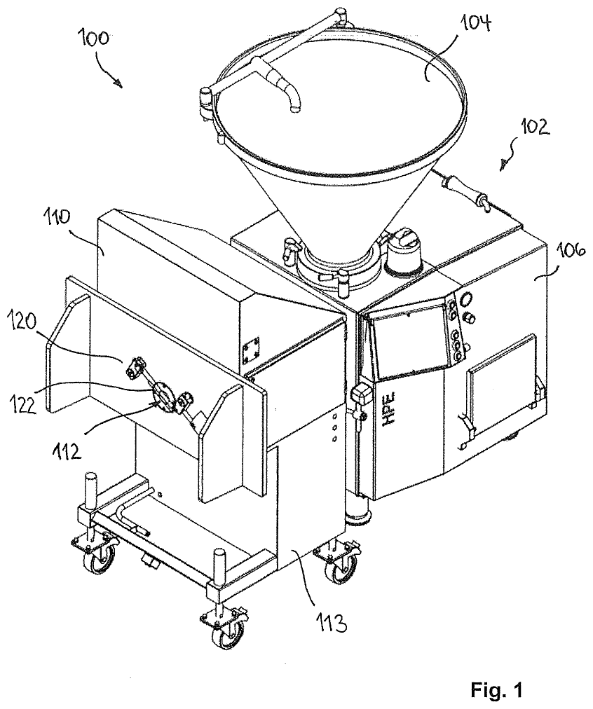

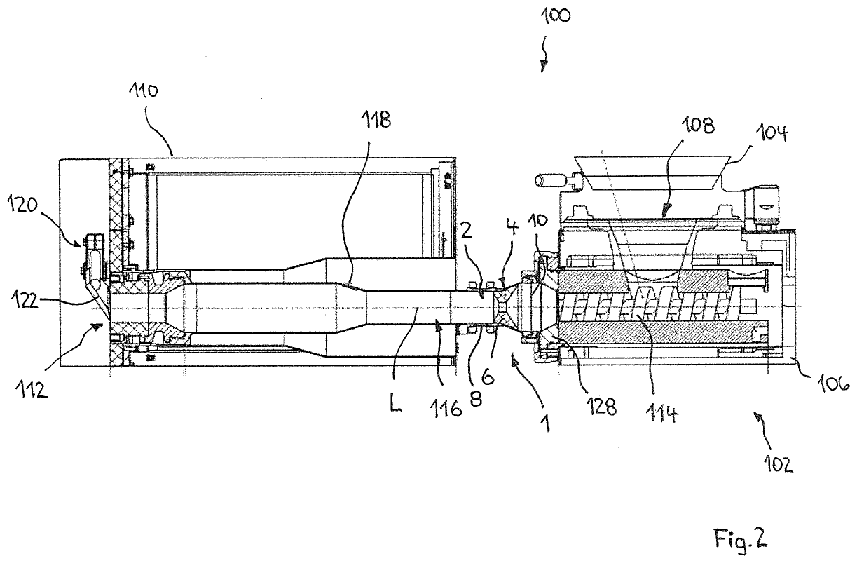

FIG. 1 shows an apparatus 100 for processing dough. The apparatus 100 includes a filling machine 102 having a filling hopper 104 for receiving dough, arranged on a housing 106 of the filling machine 102. In this arrangement the filling hopper 104 forms a dough feed opening 108 for the dough to be processed by means of the apparatus 100. The filling machine 102 further has a delivery pump 114 (FIG. 2), an outlet for the discharge of dough, a control means and further known components. Coupled to the filling machine 102 is a portioning device 110 in such a way that dough can be fed to the portioning device 110 in the delivery direction.

In the present embodiment the portioning device 110 is adapted to subdivide the dough to be processed in the apparatus into individual portions. The portioning device 110 has a dough discharge opening 112 for discharge of the dough from the apparatus 100. In the present structure the portioning device 110 is in the form of an attachment for the filling machine 102. If necessary the portioning device 110 can be replaced by means of its displaceable frame structure 113. The term attachment for the filling machine 102 in the present case is used to mean a component which is connected downstream of the filling machine 102, that is to say it is arranged after the filling machine in the delivery direction of the dough to be processed, or downstream thereof.

FIG. 2 shows a partial view in section of the filling machine 102 and the portioning device 110. As can be seen from FIG. 2 the filling machine 102 has a delivery pump 114. By means of the delivery pump 114 the dough introduced into the filling machine by way of the filling hopper 104 is delivered in the direction of the discharge opening 112 of the portioning device 110. A substantially closed processing section 116 for the dough to be processed therein is provided between the feed opening 108 and the discharge opening 112.

A dough handling unit 1 is arranged downstream of the filling machine 102, preferably in a portion of the delivery section 116. In the illustrated embodiment the dough handling unit 1 preferably forms a processing region between the filling machine 102 and the portioning device 110. In the illustrated arrangement the dough handling unit 1 is connected in fluid-conducting relationship to a filling machine connection 128. The dough handling unit 1 includes a handling chamber 2 delimited by walls, having a dough structuring unit portion 4 for a dough which is flowing through the arrangement and passing through the handling unit 2. The dough structuring portion 4 has a nozzle 6 which reduces the flow cross-section in the handling chamber 2 and which is adapted to structure/restructure the dough. Downstream of the nozzle 6 the flow cross-section of the dough structuring portion 4 in the handling chamber 2 is enlarged again in relation to the reduced flow cross-section in the region of the nozzle 6. The present configuration of the dough structuring portion 4 provides for structuring/restructuring of the dough to improve its rheological properties in particular after damage in the dough structure or after a negative influence caused by the delivery pump 114.

In operation after passing through the dough handling unit 1 the dough is conveyed in the direction of the portioning device 110. In that case the dough passes through a portion 118 within the processing section 116, which is of a flow cross-section that enlarges again in comparison with the handling chamber 2. Accordingly the speed of the dough being conveyed slows down once again in the portion.

Provided at the outlet of the portioning device 110 is a separating device 120 for subdividing the foodstuff into individual portions. The separating device 120 has at least two moveable separating blades 122. In the illustrated embodiment the separating blades 122 are mounted rotatably. Each separating blade 122 rotates at an adjustable speed and passes the discharge opening 112 at uniform intervals so that suitable individual portions are continuously cut off from a string of dough which in particular is being continuously delivered.

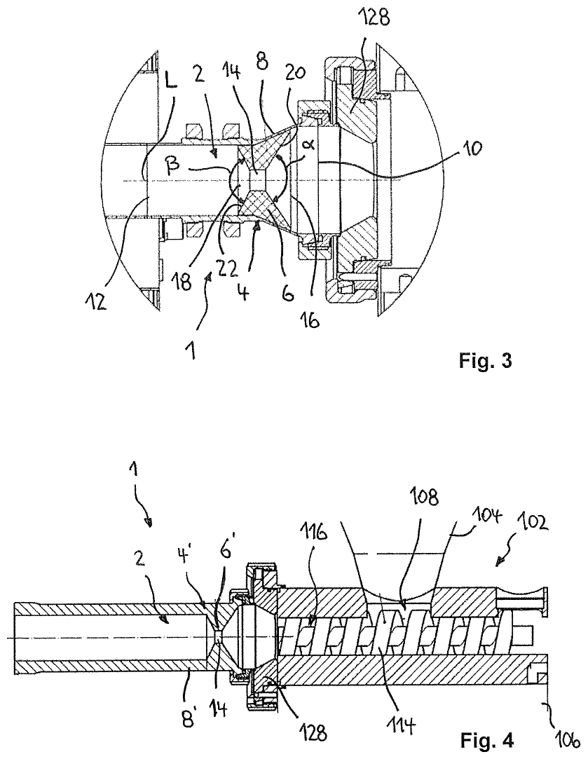

FIG. 3 shows an enlarged view of a first embodiment of the dough handling unit 1 having a housing 8 which defines the handling chamber 2 for handling the dough. In addition the handling unit 1 has a dough inlet 10 for introducing dough into the housing 8 and a dough outlet 12 for the discharge of dough from the housing 8. Arranged within the housing 8 and thus in the handling chamber 2 is the dough structuring portion 4 which is formed from a nozzle 6.

As FIG. 3 further shows the nozzle 6 has a central through opening 14 which in the illustrated embodiment is of a flow cross-section which remains the same, but it can also involve flow cross-sections which vary in the delivery direction of the dough or along the longitudinal axis L. In the present case the central passage opening 14 is of a round cross-section, with the central axis of the passage opening 14 being coaxial with respect to the longitudinal axis L of the housing 8. In the present case the housing 8 is substantially rotationally symmetrical and forms a kind of communicating tube between the filling machine 102 and the portioning device 110.

In the FIG. 3 embodiment the nozzle has an entry 16 and an exit 18. In comparison with the entry 16 at the nozzle the exit 18 is of a reduced cross-section. The central passage opening 14 is of a diameter which in comparison with the diameter of the housing 8 before and after the dough structuring portion 4 is in a ratio which is in the range of about 1:3 to about 1:12.

In the present embodiment the nozzle 6 has a portion which narrows from the entry 16 in the direction of the central passage opening 14, preferably being a conically tapering entry cone 20. The entry cone 20 has a cone angle α in the range of about 100° to 120°. The nozzle 6 preferably has a portion which enlarges from the central passage opening 14 to the exit 18, preferably a conically enlarging exit cone 22. The exit cone 22 has a cone angle β in the range of about 115° to 135°.

As FIG. 3 shows the nozzle 6 is preferably in the form of a separate component and is arranged in a portion in the handling chamber 2 of the housing 8. In the present case the nozzle 6 is interchangeable. If necessary or in dependence on the dough materials to be processed by means of the processing apparatus 100 the nozzle 6 can be replaced by a correspondingly different suitable nozzle involving different dimensions. Alternatively it could also be integral on the housing 8, as described hereinafter.

FIG. 4 shows an alternative configuration of a dough handling unit 1 having a dough structuring portion 4′ having a nozzle 6′ which is integral with at least a part of the housing 8′ of the handling unit 1. In the event of a product change the complete housing 8′ of the handling unit 1 is to be replaced, instead of only the nozzle 6 shown in FIG. 3. The FIG. 4 dough structuring unit portion 4′ therefore has all the features described in relation to the embodiment shown in FIG. 3. The identical features are denoted by the same references. The housing 8′, in contrast to the housing 8 in FIG. 3, is of a greater material thickness. The dough handling unit 1 shown in FIGS. 1 through 4 is arranged before a portioning device 110 in the delivery direction of the dough.

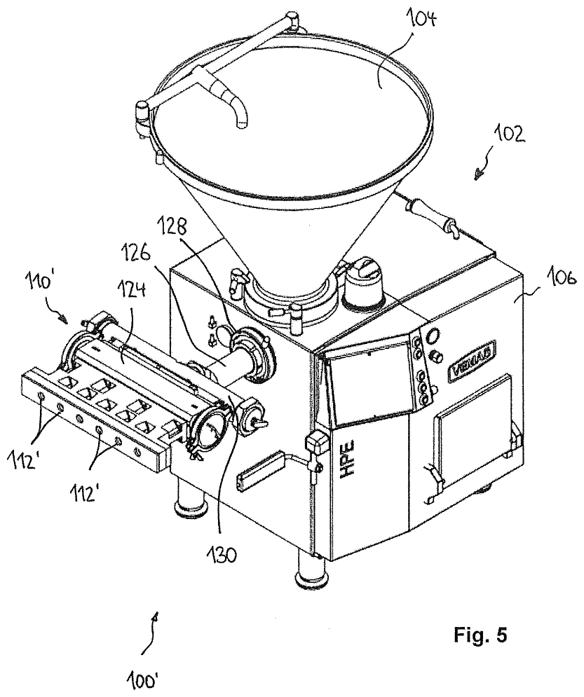

FIG. 5 shows an alternative configuration of an apparatus 100′ for processing dough. Like the previous configuration, the apparatus 100′ includes a filling machine 102 having a filling hopper 104 for receiving dough. The filling hopper 104 is arranged on the housing 106 of the filling machine. In the present case here too the filling hopper 104 defines the dough feed opening 108 for the dough to be processed by means of the apparatus 100′. A portioning device 110′ is coupled to the filling machine 102.

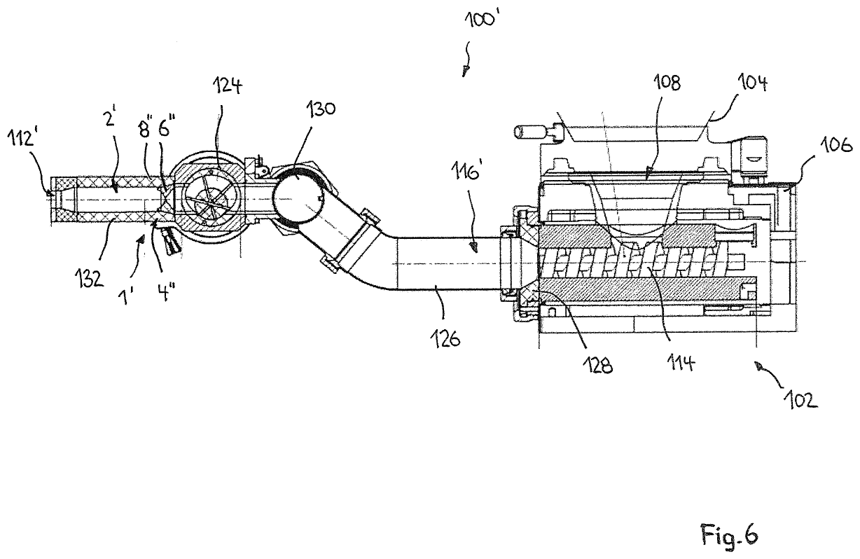

In this configuration the portioning device 110′ is adapted to subdivide the dough to be processed in the apparatus 100′ into a plurality of mass flows of the same size. The portioning device 110 includes a filling flow divider 124 coupled to the filling machine connection 128 by way of a connecting conduit 126. The filling flow divider 124 has a distributor tube 130 which extends transversely to the delivery direction of the dough material and by which the dough material is distributed by means of the filling flow divider to a plurality of discharge conduits 132 (FIG. 6). Depending on the number of discharge conduits 132 at the filling flow divider 124 the portioning device 110′ has a corresponding number of discharge openings 112′. The portioning device 110′ is also in the form of an attachment for the filling machine 102, which can be dismantled from the filling machine connection 128 again.

FIG. 6 shows a partial view in section of the filling machine 102 and the portioning device 110′. The filling machine 102 has a delivery pump 114 for the dough to be conveyed from the filling hopper 104 in the direction of the filling machine connection 128. In the present embodiment the delivery pump 114 is in the form of a worm pump. The dough material is further passed into the filling flow divider by way of the connecting conduit 126 by way of the distributor tube 140 by virtue of the delivery flow created by means of the delivery pump 114. From the filling flow divider 124 the dough material is then distributed to a plurality of successively arranged discharge conduits 132. The mass flows of the same size are then discharged by way of the discharge opening 112′ of the portioning device 110′. This embodiment of the apparatus 100 according to the invention also has a substantially closed processing section 116′ extending from the feed opening 108 to the discharge openings 112′.

Disposed in the portioning device 110′ in the delivery direction 133 of the dough downstream of the filling flow divider 124 is a dough handling unit 1′ having a handling chamber 2′ for handling the dough within the discharge conduits 132. The handling chamber 2′ and the housing 8″ of the dough handling unit 1′ is at least partially defined by the discharge conduits 132. A dough structuring portion 4″ having a nozzle 6″ is arranged in the handling chamber 2′. The nozzle 6″ is adapted to structure/restructure the dough when passing through the structuring portion 4″. The flow cross-section in the handling chamber 2′ is also reduced with the nozzle 6″ in such a way as to effect mechanical stressing of the dough material passed through the dough handling unit 1′. Downstream of the nozzle 6″ the flow cross-section in the handling chamber 2 is then enlarged again almost to the original value upstream of the nozzle 6″.

With the embodiment shown here subsequent handling of the dough material is effected immediately after the portioning process. The corresponding divided mass flows, after their subsequent treatment, are then discharged directly in the direction of the discharge openings 112′ of the portioning device 110′.

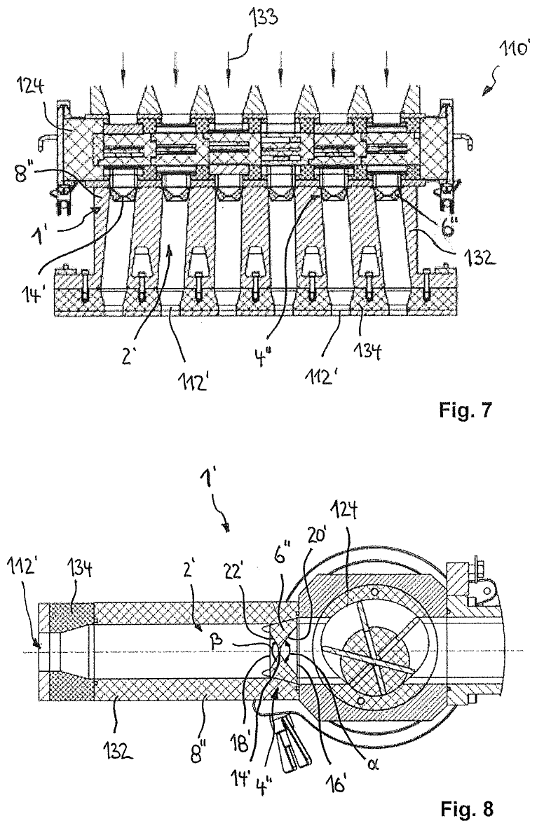

FIGS. 7 and 8 show an enlarged view of an embodiment of the dough handling unit 1′. The dough handling unit 1′ is coupled with its dough inlet 10′ at the housing 8″ directly to the filling flow divider 124. The dough outlet 12′ on the housing 8″ is connected to a narrowing outlet region 134 of the portioning device 110′. The nozzle 6″ is arranged at the beginning of the dough handling chamber 2′, the inlet 6′ of the nozzle 6″ coinciding with the inlet 10′ on the housing 8″.

As in the previous embodiment the nozzle 6″ has a central passage opening 4′ of a uniform flow cross-section. In the present case the central passage opening 4′ is of a circular cross-section. With respect to its periphery the passage opening 14′ is uniformly spaced relative to the wall of the handling chamber 2′. The housing 8″ in the present case is substantially rotationally symmetrical.

The exit 18′ at the nozzle 6′ is smaller in comparison with the flow cross-section of the downstream-connected handling chamber 2′. From the exit 18′ at the nozzle 6″ to the subsequent handling chamber 2′ the flow cross-section enlarges abruptly in the present embodiment. In this embodiment also the central passage opening 14′ is of a diameter which, in comparison with the diameter of the housing 8′ before and after the dough structuring portion 4′, is in a ratio which is in the range of about 1:3 to about 1:12.

In the embodiment shown in FIG. 8 the nozzle 6″ has an entry cone 20′ which conically tapers from the entry 16′ in relation to the central opening 14′. The entry cone 20′ has a cone angle α in the range of about 100° to 120°. In addition the nozzle 6″ has an exit cone 22′ which also enlarges conically from the central passage opening 14′ to the exit 18′. The exit cone 22′ has a cone angle β with an angle dimension in the range of about 115° to 135°. The cone angle at the exit cone 22′ has an angle dimension which is larger in comparison with the cone angle at the entry cone 20′. Similar or identical components are denoted by the same references.

### LIST OF REFERENCES

1, 1′ dough handling unit
2, 2′ handling chamber
4, 4′, 4″ dough structuring portion
6, 6′, 6″ nozzle
8, 8′, 8″ housing
10, 10′ inlet
12, 12′ outlet
14, 14′ passage opening
16, 16′ entry
18, 18′ exit
20, 20′ entry cone
22, 22′ exit cone
α, β cone angle
100, 100′ apparatus
102 filling machine
104 filling hopper
106 housing
108 feed opening
110, 110′ portioning device
112, 112′ discharge opening
113 frame structure
114 delivery pump
116, 116′ processing section
118 portion
120 separating device
122 separating blade
124 filling flow divider
126 connecting conduit
128 filling machine connection
130 distributor conduit
132 discharge conduit
134 outlet region
L longitudinal axis

1-25. (canceled)

26. A dough handling unit for handling dough, the dough handling unit comprising
a housing;
an inlet configured for introducing the dough into the housing;
an outlet configured for discharge of the dough from the housing;
a handling chamber configured for handling the dough, the handling chamber arranged within the housing along a portion between the inlet and the outlet, and the handling chamber substantially closed off relative to the surroundings; and
a dough structuring portion arranged in the handling chamber, the dough structuring portion having a nozzle which is configured to reduce a flow cross-section for structuring of the dough, and the flow cross-section in the dough structuring portion downstream of the nozzle enlarged again in relation to the reduced flow cross-section in a region of the nozzle.

27. The dough handling unit of claim 26 wherein the nozzle is configured to structure and/or restructure the dough passing the handling chamber in dependence on a quality of the dough to be handled.

28. The dough handling unit of claim 26 wherein the nozzle has a central passage opening which is of a uniform flow cross-section in a flow direction of the dough at least portion-wise along the dough structuring portion.

29. The dough handling unit claim 28 wherein the central passage opening has a substantially circular cross-section with a central axis arranged coaxially with respect to a longitudinal axis of a wall of the housing.

30. The dough handling unit of claim 29 wherein the nozzle has a passage opening of a diameter which in relation to the diameter of the wall of the housing before and/or after the dough structuring portion is in a ratio which is in a range of approximately 1:3 to about 1:12.

31. The dough handling unit of claim 29 wherein the nozzle has a passage opening, and the dough structuring portion has a flow cross-section upstream of the passage opening which continuously decreases in the flow direction.

32. The dough handling unit of claim 31 wherein the flow cross-section which continuously decreases in the flow direction is in the form of an entry cone that is conically-tapering.

33. The dough handling unit of claim 32 wherein the entry cone has a cone angle (α) in a range of about 100° to about 120°.

34. The dough handling unit of claim 32 wherein the dough structuring portion downstream of the nozzle has a flow cross-section which continuously enlarges in the flow direction.

35. The dough handling unit of claim 34 wherein the flow cross-section which continuously enlarges in the flow direction is in the form of an exit cone that is conically-enlarging.

36. The dough handling unit of claim 35 wherein the exit cone has a cone angle (β) in a range of about 115° to about 135°.

37. The dough handling unit of claim 35 wherein the entry cone has a cone angle (α), and the exit cone has a cone angle (β) that is greater than the cone angle (α) of the entry cone.

38. The dough handling unit of claim 26 wherein the handling chamber includes a substantially cylindrical space downstream of the dough structuring portion and the substantially cylindrical space downstream is configured for portioning of the dough.

39. The dough handling unit of claim 26 wherein the handling chamber has a length, the nozzle has a length, and the length of the handling chamber and the length of the nozzle are in a ratio of 4:1.

40. The dough handling unit of claim 26 wherein the handling chamber includes at least one baffle arranged in downstream of the nozzle in a region of the handling chamber having an increase in cross-section.

41. The dough handling unit of claim 26 wherein the nozzle is integral with at least a part of the housing.

42. The dough handling unit of claim 26 wherein the dough structuring portion is in the form of a separate component and is replaceably arranged in a portion of the handling chamber.

43. An apparatus for processing dough, the apparatus comprising:
a dough handling unit for handling the dough, the dough handling unit comprising a housing, an inlet configured for introducing the dough into the housing, an outlet configured for discharge of the dough from the housing, a handling chamber configured for handling the dough, and a dough structuring portion arranged in the handling chamber, the handling chamber arranged within the housing along a portion between the inlet and the outlet, the handling chamber substantially closed off relative to the surroundings, the dough structuring portion having a nozzle which is configured to reduce a flow cross-section for structuring of the dough, and the flow cross-section in the dough structuring portion downstream of the nozzle enlarged again in relation to the reduced flow cross-section in a region of the nozzle; and
a filling machine coupled to the dough handling unit, the filling machine including a filling hopper configured for receiving the dough and a delivery pump configured for delivery of the dough to the dough handling unit,
wherein the dough handling unit arranged downstream of the delivery pump.

44. The apparatus of claim 43 wherein the filling hopper includes a feed opening, and the filling machine includes a discharge opening and a processing section which extends between the feed opening and the discharge opening, and the processing section is substantially closed in relation to the surroundings.

45. The apparatus of claim 44 further comprising:
a portioning device configured for subdividing the dough passing the processing section into individual portions or into a plurality of same-size mass flows.

46. The apparatus of claim 45 wherein the processing section includes at least one feed location configured for additives to be added to the dough to be handled.

47. The apparatus of claim 45 wherein the portioning device includes a separating device for subdividing the dough into individual portions, and the separating device includes at least one moveable blade.

48. A method of processing dough, the method comprising:
introducing a dough into a dough feed opening of a substantially-closed processing section;
delivering the dough in the processing section by a filling machine in a direction of a dough discharge opening, wherein the dough passes through a handling unit which is arranged after the filling machine in a delivery direction of the dough; and
handling the dough in the handling unit by passing the dough through a dough structuring portion with a nozzle reducing the flow cross-section for structuring of the dough.
